(19) United States
(12) Patent Application Publication
(10) Pub. No.: US 2021/0234941 A1
(43) Pub. Date: Jul. 29, 2021

(54) Wireless Device, Computer Server Node, and Methods Thereof

(71) Applicant: Telefonaktiebolaget LM Ericsson (publ), Stockholm (SE)

(72) Inventors: Peter Ökvist, Luleå (SE); Hans Hannu, Luleå (SE); Tommy Arngren, Södra Sunderbyn (SE); Anders Landström, Boden (SE); David Lindero, Luleå (SE)

(21) Appl. No.: 17/257,145

(22) PCT Filed: Jul. 4, 2018
(86) PCT No.: PCT/EP2018/068097

§ 371 Date: Dec. 30, 2020

(51) Int. Cl. H04L 29/08; G06F 16/583; G06F 16/587; G06T 7/00

(52) U.S. Cl. CPC H04L 67/327; G06T 7/0002; G06F 16/587; G06F 16/5854

(57) ABSTRACT

According to an aspect, a wireless device receives (302) a preview digital image from a computer server and applies object recognition processing (304) to the preview digital image, to determine (306) whether the preview digital image contains a representation of a known object of interest. Responsive to a positive determination, the wireless device transmits (308) an indication of the positive determination. The computer server sends, in response to the transmitted indication, an enhanced digital image corresponding to the preview digital image, or additional image data, which is received (310) by the wireless device. In the latter case, the wireless device forms an enhanced version of the preview digital image using the additional image data. The wireless device at least temporarily stores (312) the enhanced image or image version, e.g., for rendering on a display screen of the device.

### TECHNICAL FIELD

The present invention is related to methods of operation by a wireless device configured for operation in a wireless communication network, wireless devices configured for operation in a wireless communication network, methods of operation by a computer server node, computer server nodes, corresponding computer program products, and corresponding computer-readable media.

### BACKGROUND

Social media feeds and similar services deliver photos, videos, and other media content to user devices, which oftentimes are smartphones, tablets, or other wireless computing devices. At large, more users of wireless communication networks are consuming more media content, more regularly, and that consumption can be “expensive” from the perspective of resource usage within the wireless networks used to deliver the content and from the perspective of individual users who have metered connections.

Even when a user does not face with aggregate data cap limitations or other metering limitations, prevailing radio conditions may not support good performance when browsing photos or other online media content via the user device. When wireless connectivity is poor or otherwise limited, the delivery of given media content to the user device over the wireless connection may require much more time than needed when operating with good wireless connectivity.

Multiple scenarios exist, therefore, in which a user may incur service costs, deplete a data allocation, or suffer a poor user experience, in conjunction with retrieving media content over a wireless connection. Recognized herein is the fact that media content having some putative interest to the user may not be interesting to the user. For example, a user may have a particular event, such as a game or school function, but that interest may be focused on a child, friend, or other particularized individual participating in the event.

### SUMMARY

Methods and apparatuses described in example form herein improve the operation of wireless communication devices, hereinafter also referred to as user devices or wireless devices, used for browsing or retrieving media content over a wireless connection, improve server-side operations associated with delivering such content, and improve network operations by reducing the amount or duration of network loading and radio resource consumption used for delivering media content. In at least some embodiments, these improvements flow from the advantageous use of user preferences, such as may be known or extracted from data locally available on a user device being used to browse online media content. According to one technique described herein, one or more “objects of interest” are known from user-related information which may either be stored locally on the user device or separately from the user device, e.g., photo library information, contact lists, social media accounts, etc. The user device determines whether a preview digital image received over a wireless connection contains any representations of an object of interest, as known from the local information and obtains further image data responsive to a positive determination. The further image data may be an enhanced version of the preview digital image or may be additional image data from which the user device generates an enhanced version of the preview digital image. In either case, the additional overhead associated with retrieving the further image data, e.g., a higher-resolution version of the preview digital image depends on detecting one or more objects of interest in the preview digital image.

At least one example implementation prioritizes the downloading and rendering of media content (e.g., images) from an application server or computer sever node, such as a cloud-based media library system offering user's access to personal and shared photos, videos, or other media content. In a photo library or photo sharing example, prioritization uses characteristics of certain parts or pre-determined features within an image, such as familiar faces, people, pets, etc. Advantageously, the approach exploits information available on the user's wireless device (e.g., tablet, smartphone, or other user equipment) or an application server that is informative of what part of a to-be-downloaded image would be most interesting to the user. Such information may include the user's social connections or other information indicating that some part of the image might be more interesting or relevant. For example, familiar faces and persons are generally more relevant to a user and most likely are registered or otherwise defined in a photo library or contact database associated with the user.

In one example, a user requests an image using an online social service like a FACEBOOK application or an INSTAGRAM account and the user device provides prioritized image characteristics to the server upon a request for an image download. The computer server matches the criteria and responds with high resolution image data for the image part or sub-area that contains the prioritized image criteria. The prioritized image area within an incoming image can correspond to a specific face identified from facial images in the user's camera album and/or information in a contact list associated with a user of the wireless device. The server can also transcode the image to create low resolution alternatives for the non-prioritized parts of the image.

Note that prioritization in this context can mean at least two things. First, a prioritized part of an image can be the part of the image that will be downloaded first, while other parts of the same image are downloaded later or not at all. Second, it means that a prioritized part of an image may receive a higher transmission priority over non-prioritized parts of the same image.

According to some embodiments, a method of operation by a wireless device configured for operation in a wireless communication network includes receiving a preview digital image from a computer server node via a wireless connection to the wireless communication network and applying object recognition processing to the preview digital image, to determine whether the preview digital image contains a representation of a known object of interest. Objects of interest may be part of an image or pre-determined features of an image that are known or expected to be interesting to the user. Objects of interest may be, for example, faces, people, pets, or things known from the user's photo library. The preview digital image can be received as a result of a user request for the digital image or an automatic push feed of preview digital images by an application. The method further includes, responsive to a positive determination, transmitting an indication of the positive determination to the computer server node via the wireless connection and receiving, in response to the transmitted indication, an enhanced digital image from the computer server node corresponding to the preview digital image, or receiving additional image data from the computer server node and forming an enhanced version of the preview digital image using the additional image data, and storing the enhanced digital image or the enhanced version of the preview digital image at least temporarily in the wireless device. For example, the device at least temporarily stores the enhanced image or enhanced version of the preview image at least temporarily and renders or otherwise displays it.

According to some embodiments, a wireless device configured for operation in a wireless communication network includes communication circuitry and processing circuitry. The communication circuitry is configured for wirelessly connecting to a wireless communication network. The processing circuitry is configured to receive, via the communication circuitry, a preview digital image from a computer server node, the preview digital image sent to the wireless device over a wireless connection between the wireless device and the wireless communication network, and apply object recognition processing to the preview digital image, to determine whether the preview digital image contains a representation of a known object of interest. The processing circuitry is also configured to, responsive to a positive determination, transmit, via the communication circuitry, an indication of the positive determination to the computer server node via the wireless communication network. The processing circuitry is also configured to receive, via the communication circuitry and in response to the transmitted indication, an enhanced digital image from the computer server node corresponding to the preview digital image or receive additional image data from the computer server node and form an enhanced version of the preview digital image using the additional image data. The processing circuitry carries out the reception and transmission operations using the communication circuitry of the wireless device and it is further configured to store the enhanced digital image or the enhanced version of the preview digital image at least temporarily in the wireless device.

According to some embodiments, a method of operation by a computer server node includes sending a preview digital image towards a wireless device that is communicatively coupled to the computer server node by a wireless connection provided by a wireless communication network. The method includes receiving an indication originating from the wireless device in response to the wireless device detecting a representation of a known object of interest in the preview digital image and responding to the indication by sending towards the wireless device an enhanced digital image corresponding to the preview digital image, or by sending additional image data for use by the wireless device in enhancing the preview digital image.

According to some embodiments, a computer server node includes communication circuitry configured to communicate directly or indirectly with a wireless device that is communicatively coupled to the computer server node via a wireless connection to a wireless communication network and processing circuitry operatively associated with the communication circuitry. The processing circuitry is configured to send a preview digital image towards the wireless device and receive an indication originating from the wireless device in response to the wireless device detecting a representation of a known object of interest in the preview digital image. The processing circuitry is also configured to respond to the indication by sending towards the wireless device an enhanced digital image corresponding to the preview digital image, or by sending additional image data for use by the wireless device in enhancing the preview digital image.

These and other embodiments improve end user satisfaction by enabling efficient and prioritized downloading and rendering of image data, to reduce delays in displaying the most relevant parts of an image in full resolution.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates a wireless communication network used for enabling downloading and rendering of media images, according to some embodiments.

FIG. 2 illustrates block diagrams of a wireless device and a computer server node that operate in the wireless communication network, according to some embodiments.

FIG. 3 is a flowchart illustrating a method carried out by the wireless device, according to some embodiments.

FIG. 4 is a flowchart illustrating a method carried out by the computer server node, according to some embodiments.

FIG. 5 is a flowchart illustrating prioritized download of image data, according to some embodiments.

FIG. 6 is a signaling diagram illustrating the creation and use of identifying data for the prioritized download of image data of FIG. 5, according to some embodiments.

FIG. 7 is a signaling diagram illustrating another embodiment.

FIG. 8 is a signaling diagram illustrating another embodiment.

FIG. 9 is a signaling diagram illustrating another embodiment.

### DETAILED DESCRIPTION

Embodiments of the present invention improve the user experience associated with the transfer of media content and the rendering of images, including images in videos or video streams. One aspect associated with multimedia is that a user may be satisfied with less resolution or a slower rendering of image parts that are less important. On the other hand, faces may be of higher importance within an image, with familiar or beloved faces being of highest importance. These parts of an image call for higher quality and a quicker rendering at full resolution.

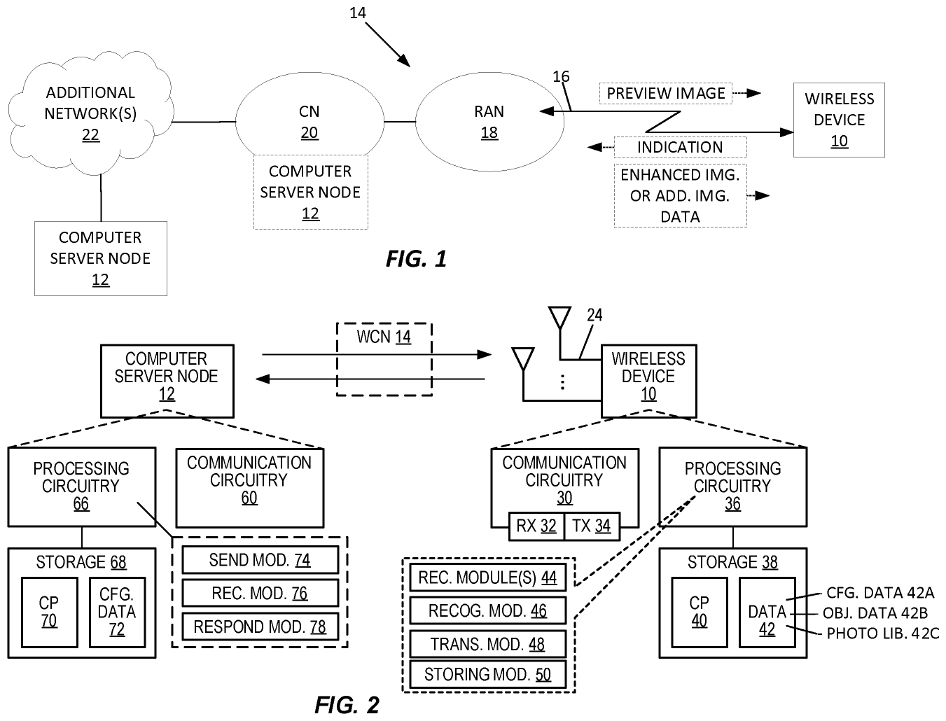

FIG. 1 illustrates an example embodiment of a wireless communication network 14 with components or associated entities that perform prioritized downloading and rendering of known objects of interest, or the more relevant or interesting parts of a media image. The network 14 communicatively couples a wireless device 10 to a computer server node 12 that provides media to the wireless device 10. That is, media transfers from the computer server node 12 to the wireless device 10 are carried over a wireless connection or link 16 between equipment in a Radio Access Network (RAN) 18 portion of the network 14 and the wireless device 10. The example network 14 further includes a core network (CN) 20 that communicatively couples the wireless device 10 to one or more additional networks 22, such as the Internet. In the present context, it shall be appreciated that the computer server node 12 may be implemented in an additional network 22 or in the CN 20. Thus, the diagram illustrates the computer server node 12 twice; once using solid lines to indicate an example location and interconnection, and once using dashed lines to indicate an alternative location and interconnection.

Advantageously, the wireless device 10 is configured for operation in a manner that allows it to process preview digital images from a server node 12, to determine whether the preview image contains a representation of a known object of interest (e.g., a familiar face). The wireless device 10 transmits, via a wireless connection 16, an indication of a positive determination to the server node 12, which then returns an enhanced digital image or additional image data corresponding to the preview digital image. Without implying the absence of other advantages or features, the foregoing operations should be appreciated as substantively improving operation of the wireless device 10 and, particularly, improving media transfer between the network 14 and the wireless device 10. To wit, the wireless device 10 saves wireless bandwidth or otherwise reduces the aggregate amount of data transfer by evaluating preview digital images to determine whether further image data should be transferred to the wireless device 10, e.g., a corresponding enhanced digital image or additional image data from which the wireless device 10 generates an enhanced version of the preview digital image. Notably, obtaining the further image data depends on detecting that the preview digital image contains one or more objects of known interest, such as may be known directly or indirectly from the contents of a user's photo library.

FIG. 2 depicts example implementation details for the wireless device 10 and the server node 12 that delivers media content to wireless device 10, where the delivery may be upon request by the device 10 or as a push operation by the server node 12. Those skilled in the art will recognize the depicted example as non-limiting, as the functionality of interest may be realized using other physical and functional circuitry arrangements. With these qualifiers in mind, the example wireless device 10 includes communication circuitry 30 for wirelessly connecting to the network 14 over a wireless connection 16, for communicatively coupling with the computer server node 12. The computer server node 12 may be part of the network 14, or may be external to the network 14.

In an example implementation, the communication circuitry 30 includes receiving circuitry 32 for receiving signals and transmitting circuitry 34 for transmitting signals, using one or more antennas 24. Thus, in one or more embodiments, the wireless device 10 is configured to implement the air interface (radio protocols) used by the network 14 and, in one or more embodiments, implements one or more further protocols, such as higher-layer protocols like Quick User Datagram Protocol (UDP) Internet Connections (QUIC). In another example embodiment, the communication circuitry 30 couples to the network 14 over a Wi-Fi or other local wireless connection, e.g., to a Wi-Fi access point that provides backend connectivity to the network 14. Thus, in non-limiting example cases, the wireless connection 16 may be a Wide Area Network (WAN) connection, such as a cellular connection, or may be a Wireless Local Area Network (WLAN) connection.

The wireless device 10 further includes processing circuitry 36, which may comprise one or more Central Processing Units (CPUs), along with supporting storage 38. The storage 38 comprises one or more types of computer-readable media, such as a combination of one or more types of long-term storage and one or more types of dynamic or working storage. In an example implementation, the storage 38 comprises one or more types of non-volatile storage, such as Solid State Disk, hard disk, FLASH, etc., and one or more types of volatile storage, such as Static RAM, Dynamic RAM, etc.

Broadly, the processing circuitry 36 should be understood as comprising fixed circuitry or programmatically-configured circuitry or some combination of fixed circuitry and programmatically-configured circuitry. In one or more embodiments, for example, the processing circuitry 36 comprises one or more microprocessors, microcontrollers, Digital Signal Processors (DSPs), Application Specific Integrated Circuits (ASICs), Field Programmable Gate Arrays (FPGAs), or other digital processing circuits that are specially adapted—configured—to operate as described herein, based on their execution of computer program instructions comprising one or more computer programs stored in the storage 38. As an example of such an arrangement, FIG. 2 depicts the storage 38 as storing one or more computer programs, denoted as CP 40 in the diagram, along with configuration data 42A, which may comprise preconfigured information, dynamically configured information, or a mix thereof. The storage 38 may also include object data 42B and a photo library 42C. The object data 42B comprises, for example, one or more object templates that represent one or more objects of interest in parameterized form, e.g., based on feature parameterization or the like. The template may be generated or derived from, for example, the photo library 42C, which in turn may reside locally in the device 10.

In a first detailed example embodiment, the communication circuitry 30 of the computer server node 12 is configured to communicate directly or indirectly with the computer server node 12 that is communicatively coupled to the wireless device 10 via the network 14, and the processing circuitry 36 is operatively associated with the communication circuitry 30. The processing circuitry 36 is configured to receive, via the communication circuitry 30, a preview digital image sent by the network 14 over a wireless connection 16 with the wireless device 10. The processing circuitry 36 is configured to apply object recognition processing to the preview digital image, to determine whether the preview digital image contains a representation of a known object of interest. The processing circuitry 36 is also configured to, responsive to a positive determination, transmit, via the communication circuitry 30, an indication of the positive determination to the network 14 and receive, via the communication circuitry 30 and in response to the transmitted indication, an enhanced digital image corresponding to the preview digital image, or receive additional image data and form an enhanced version of the preview digital image using the additional image data. The processing circuitry 36 may further, in response to the transmitted indication, store the enhanced digital image or the enhanced version of the preview digital image at least temporarily in the wireless device, e.g., for rendering on a display screen of the device 10.

In one or more embodiments, the wireless device 10 is configured to display the preview digital image while it performs object recognition processing and/or while it acquires the enhanced digital image or additional image data for generating an enhanced version of the preview digital image. For example, the wireless device 10 is a smartphone, tablet, laptop, or other computing device having a display screen, e.g., an LCD or OLED display screen suitable for rendering photos, videos, etc. In an example case using terminology adopted by the Third Generation Partnership Project (3GPP), the wireless device 10 is a “User Equipment” or “UE”.

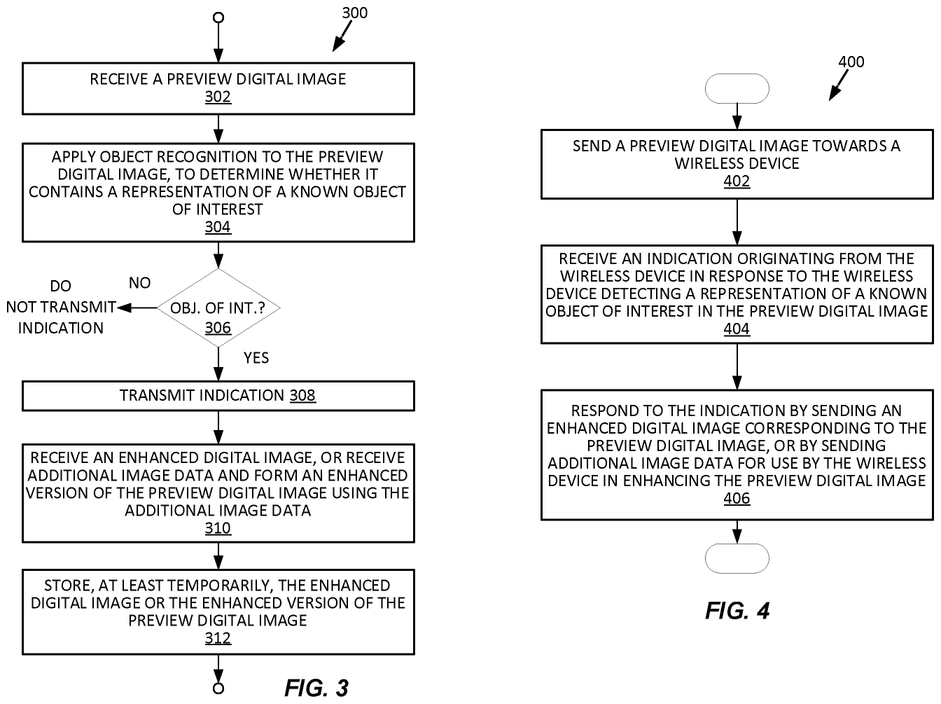

FIG. 3 illustrates an example method 300 performed by a wireless device in one or more embodiments, e.g., by the wireless device 10 introduced in FIGS. 1 and 2, based on the operation of its included processing circuitry 36. The method 300 includes receiving a preview digital image via a wireless connection 16 to a network 14 (block 302) and applying object recognition processing to the preview digital image, to determine whether the preview digital image contains a representation of a known object of interest (block 304). The method 300 also includes, responsive to a positive determination (block 306), transmitting an indication of the positive determination via the wireless connection 16 (block 308) and receiving, in response to the transmitted indication, an enhanced digital image corresponding to the preview digital image, or receiving additional image data and forming an enhanced version of the preview digital image using the additional image data (block 310). The method 300 further includes storing the enhanced digital image or the enhanced version of the preview digital image at least temporarily in the wireless device (block 312).

The method 300 may include identifying the known object of interest based on user preferences extracted from the wireless device 10. The method 300 may further include determining the known object of interest by comparing feature information extracted from the preview image with an object template library stored in the wireless device 10, the object template library being stored as object data 42B in the wireless device 10.

The known object of interest is known based on a user-provided designation for a certain object represented in one or more digital images in a photo library 42C and/or detection, via object recognition processing applied to the photo library 42C associated with the user, that more than a defined threshold number of the digital images in the photo library 42C contain representations of the certain object.

In one approach, the wireless device 10 receives the preview digital image and applies object recognition processing to it, such as by performing feature extraction operations according to a defined algorithm or algorithms. The wireless device 10 applies like object recognition processing to one or more digital images in the photo library 42C and compares the feature extraction results from the preview digital image to the feature extraction results obtained from the one or more photo library images, to determine the extent of correlation or matching. Another approach uses object templates, e.g., previously extracted features or sets of features, and the device 10 compares the feature-extraction results for the preview digital image with the object templates, to identify “matching” objects. Here, the matching may be an exact numerical matching, e.g., matching hash values, or may be based on there being at least a threshold level of correlation between the features extracted from the preview digital image and the features represented in an object template database stored as the object data 42B.

Thus, in some embodiments, the known object of interest is recognized based on its matching with known-object data 42B stored in the wireless device 10 and applying the object recognition processing to the preview digital image includes correlating or comparing image data comprising the preview digital image, or metrics derived therefrom, with the known-object data 42B stored in the wireless device 10. The known-object data 42B may include facial representation data for one or more reference faces and correlating or comparing the image data comprising the preview digital image, or metrics derived therefrom, with the known-object data 42B includes performing facial recognition processing on the preview digital image and comparing any detected faces with the one or more reference faces, where the comparison uses a common representation scheme for the detected faces and the reference faces.

The processing may further include the use of a feature map from which the extents of the object-of-interest in the preview image can be determined—i.e., how “much” of the preview digital image constitutes the object of interest. In turn, that determination can be used to control, for example, whether the device 10 requests and/or the network 14 delivers an enhanced digital image as a higher-quality replacement for the preview digital image or delivers further image data for use in generating an enhanced version of the preview digital image.

The preview digital image may have a first resolution, where the indication of the positive determination is a request for further image data for rendering a region of the preview digital image containing the representation of the known object of interest at a second resolution that is higher than the first resolution. “Resolution” refers to spatial resolution—e.g., number of pixels or pixel density—in one or more embodiments. Alternatively, or in addition, “resolution” refers to color depth. More broadly, the term “resolution” refers to the level of detail associated with the image, such that a higher-resolution image is more detailed in one or more respects than a lower-resolution image.

Receiving the enhanced digital image or the additional image data may include receiving the further image data as the additional image data and enhancing the region of the preview digital image containing the representation of the known object of interest using the further image data, to obtain the enhanced version of the preview digital image. The preview digital image may include a set of macro blocks and requesting the further image data may include identifying the one or more macro blocks constituting the region of the preview digital image containing the representation of the known object of interest.

In some embodiments, the preview digital image has a first resolution, where the indication is a request for the enhanced digital image, the enhanced digital image having a second resolution that is higher than the first resolution.

Regarding details for the example server node 12 shown in FIG. 2, the server node 12 includes communication circuitry 60 for providing the media content to a wireless device 10 via the network. The example server node 12 further includes processing circuitry 66, which may comprise one or more CPUs, along with supporting storage 68. The storage 68 comprises one or more types of computer-readable media, such as a combination of one or more types of long-term storage and one or more types of dynamic or working storage. In an example implementation, the storage 68 comprises one or more types of non-volatile storage, such as Solid State Disk, hard disk, FLASH, etc., and one or more types of volatile storage, such as Static RAM, Dynamic RAM, etc.

Broadly, the processing circuitry 66 should be understood as comprising fixed, dedicated circuitry or programmatically-configured circuitry, or some combination of fixed circuitry and programmatically-configured circuitry. In one or more embodiments, for example, the processing circuitry 66 comprises one or more microprocessors, microcontrollers, DSPs, ASICs, FPGAs, or other digital processing circuits that are specially adapted—configured—to operate as described herein, based on their execution of computer program instructions comprising one or more computer programs stored in the storage 68. As an example of such an arrangement, FIG. 2 depicts the storage 68 as storing one or more computer programs, denoted as CP 70 in the diagram, along with configuration data 72, which may comprise preconfigured information, dynamically configured information, or a mix thereof.

In a first detailed example embodiment, the communication circuitry 60 of the computer server node 12 is configured to communicate directly or indirectly with the wireless device 10 that is communicatively coupled to the server node 12 via a wireless connection 16 to the network 14, and the processing circuitry 66 is operatively associated with the communication circuitry 60. The processing circuitry 66 is configured to send a preview digital image via a wireless connection 16 to the wireless device 10. The processing circuitry 66 is also configured to receive an indication originating from the wireless device 10 in response to the wireless device 10 detecting a representation of a known object of interest in the preview digital image. The processing circuitry 66 is configured to respond to the indication by sending, towards the wireless device 10, an enhanced digital image corresponding to the preview digital image, or by sending additional image data for use by the wireless device 10 in enhancing the preview digital image.

In some embodiments, the indication may include a request for the enhanced digital image, and the processing circuitry 66 may be configured to respond to the request by sending the enhanced digital image. In other embodiments, the indication may include a request for further image data for a region of the preview digital image, and the processing circuitry 66 may be configured to respond to the request by sending, as the additional image data, the further image data identified in the request.

The request for the further image data may include an identification of one or more macro blocks of the preview digital image, where the preview digital image includes a set of macro blocks, and where the processing circuitry 66 is configured to respond to the request by sending additional image data for the identified macro blocks.

The processing circuitry 66 is also configured to perform a corresponding method, such as method 400 shown in FIG. 4. The method 400 includes sending a preview digital image towards a wireless device 10 that is communicatively coupled to the server node 12 by a wireless connection 16 provided by a wireless communication network 14 (block 402) and receiving an indication originating from the wireless device 10 in response to the wireless device 10 detecting a representation of a known object of interest in the preview digital image (block 404). The method 400 also includes responding to the indication by sending towards the wireless device 10 an enhanced digital image corresponding to the preview digital image, or by sending additional image data for use by the wireless device 10 in enhancing the preview digital image (block 406).

In some embodiments, the indication includes a request for the enhanced digital image and responding to the indication includes sending the enhanced digital image. In other embodiments, the indication includes a request for further image data for a region of the preview digital image, and responding to the indication includes sending, as the additional image data, the further image data identified in the request. The request for the further image data may include an identification of one or more macro blocks of the preview digital image, where the preview digital image comprises a set of macro blocks, and where sending the further image data includes sending additional image data for the identified macro blocks.

FIG. 2 also illustrates functional implementations of the operations that can be performed by the wireless device 10 and the server node 12. The wireless device 10 includes receiving module(s) 44 for receiving a preview digital image via a wireless connection to the wireless communication network and a recognition module 46 for applying object recognition processing to the preview digital image, to determine whether the preview digital image contains a representation of a known object of interest. The implementation further includes a transmission module 48 for, responsive to a positive determination, transmitting an indication of the positive determination via the wireless connection. The receiving module(s) 44 is also for receiving, in response to the transmitted indication, an enhanced digital image corresponding to the preview digital image, or receiving additional image data and forming an enhanced version of the preview digital image using the additional image data. The implementation also includes a storing module 50 for, in response to the positive determination, storing the enhanced digital image or the enhanced version of the preview digital image at least temporarily in the wireless device.

As for the functional implementation in the server node 12, the server node 12 includes a sending module 74 for sending a preview digital image towards a wireless device that is communicatively coupled to the computer server node by a wireless connection provided by a wireless communication network. The implementation includes a receiving module 76 for receiving an indication originating from the wireless device in response to the wireless device detecting a representation of a known object of interest in the preview digital image and a responding module 78 for responding to the indication by sending towards the wireless device an enhanced digital image corresponding to the preview digital image, or by sending additional image data for use by the wireless device in enhancing the preview digital image

Another embodiment involves a computer program product, e.g., one or more computer programs 40 stored non-transitorily in the storage 38 or stored in another computer-readable medium of the wireless device 10. The computer program product includes program instructions that, when executed by one or more CPUs or other processors operative as the processing circuitry 36 of a wireless device 10 configured for operation in the network 14, configures the wireless device 10 to perform the method 300 shown in FIG. 3.

Another embodiment involves a computer program product, e.g., one or more computer programs 70 stored non-transitorily in the storage 68 or stored in another computer-readable medium of the server node 12. The computer program product includes program instructions that, when executed by one or more CPUs or other processors operative as the processing circuitry 66 of a server node 12, configures the server node 12 to perform the method 400 shown in FIG. 4.

According to some embodiments, the computer server node 12 and the wireless device 10 may form a system, where the computer server node 12 and the wireless device 10 are configured to communicate indirectly through the network 14 that communicatively couples the computer server node 12 to the wireless device 10. The computer server node 12 is configured to provide a preview digital image to the wireless device 10. The wireless device 10 is configured to store information 42B, 42C defining one or more known objects of interest in terms of digital image data or metrics derived therefrom, each known object of interest corresponding to a physical thing, and further configured to send an indication to the computer server node 12 in response to determining that the preview digital image contains a representation of any one or more of the one or more known objects of interest. The computer server node 12 is further configured to respond to the indication by sending an enhanced digital image that is a higher resolution version of the preview digital image, or sending additional image data for creating an enhanced version of the preview digital image. The wireless device 10 configured to receive the enhanced digital image or the additional image data and to store at least temporarily the enhanced digital image or, in the case that the computer server node 12 sends the additional image data, form the enhanced version of the preview digital image using the additional image data, and store at least temporarily the enhanced version of the preview digital image.

Example Use Case with Additional Embodiments

The solution is described for a scenario where a father is on a trip and he is currently in a location where the data channel has limited throughput and there is a cap on the amount of data he can download. One of his children is participating in a basketball tournament for which they have an image and video application used by the tournament management team to publish images and videos from the tournament.

Obviously, the father is most interested in viewing his own kid and thus the areas of the-soon-to-be-downloaded media images of upmost interest will contain his kid's face, which can be described as a known object of interest. Now, in the scenario with limited download capability and/or a data cap, if the father starts downloading an image that potentially does not contain his kid, he wants to know that as soon as possible so that he can terminate the download of that image, without incurring further wait time and data usage against his data plan. The solutions described herein allow the father to minimize wait time for determining whether his son or daughter is in the picture, save on data use attributed to his data plan and have improved satisfaction with the application and the wireless service used to display the images.

In the example embodiments below, it can be assumed that communication between a client, agent and server can be done, for example, with Hypertext Transfer Protocol (HTTP) POST, adding parameters and coefficients as lists or JAVASCRIPT Object Notation (JSON) objects. Images can be sent with HTTP PUT or retrieved using HTTP GET but then initiated from the receiving end.

### Embodiment 1

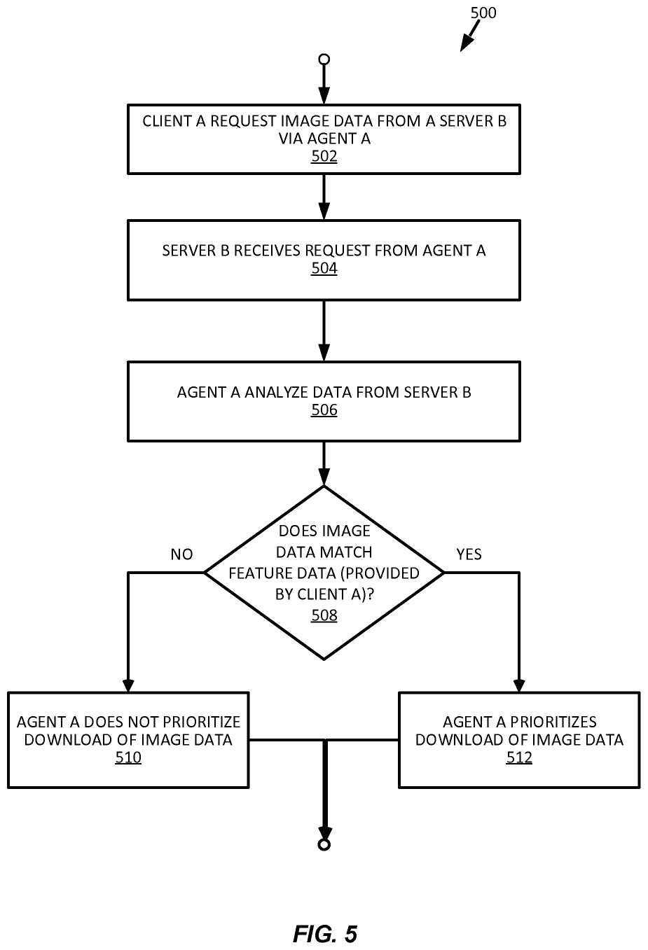

A first example embodiment under this scenario is a server-based approach. In this first embodiment, a user, e.g., a father, invokes an application on his wireless device, the application being referred to as Application A. Application A includes a Client A that runs on the father's wireless device, e.g., a User Equipment or UE. A Server A supports Client A and is accessible via the wireless communication network 14. Within Server A there is also an Agent A that will act on behalf of Client A to fetch media content that may be of interest to the father, e.g., digital image or video data from a sports tournament involving his child, as provided by an image and video Application A2 on running on Server B. The interaction of these components is shown by the flowchart 500 shown in FIG. 5, according to some embodiments.

Step 502 in FIG. 5 shows the father using Client A to send a request for new images from Server B via Agent A. Server B receives the request from Agent A at Step 504. At Step 506, Agent A will then process or analyze the images and data received from Server B. At Step 508, it is determined whether data of a feature image or video selection matches any data indicated as prioritized. Agent A either prioritizes (block 512) the download of the featured image data or does not (block 510), based on the determination (block 508).

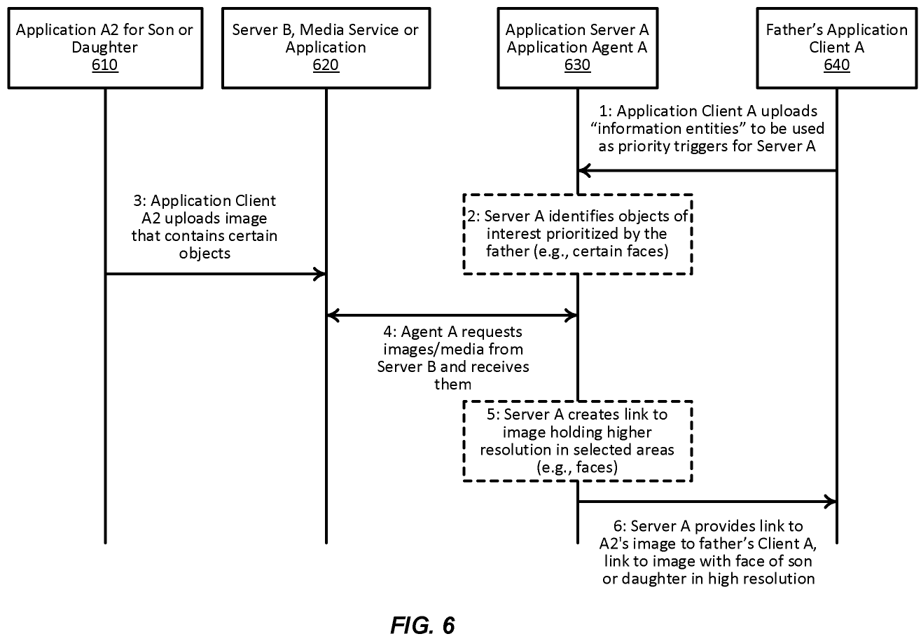

FIG. 6 shows a signaling diagram that, according to some embodiments, includes additional actions that may take place before images are requested by Client A, as shown in FIG. 5. These actions illustrated in FIG. 6 may or may not be part of the same embodiment shown by FIG. 5. For example, prior to a request by the father for current images provided by tournament Application A2 610, the father, via his Client A 640, sent media information entities to Agent A 630 (FIG. 6 Step 1) to help Agent A 630 identify and trigger prioritization objects of interest related to his son or daughter within the images on Server B 620. These media information entities can be images and/or characteristic data about parts of images of his son or daughter that correspond to his or her face, team clothes, jersey number, etc. This data can also be derived from a photo album or contact list stored in or managed by the father's device, in which his son or daughter has multiple entries. This data can further include metadata that gives identifying characteristics that are useful for the various image processing capabilities in Agent A 630. This metadata can be a team name, a color of clothes, a jersey number, etc. This metadata can also include a set of coefficients or a complete model for an image classification neural network that will help Agent A to identify the son or daughter's face, or any other known object of interest, in the images provided from Server B (i.e., “Transfer Learning”), transferred using the Neural Network Exchange Format (NNEF) for example. This data or metadata was used by Agent A 630 to identify objects of interest to the father that will be prioritized for enhancement in requested images (FIG. 6 Step 2).

Step 3 of FIG. 6 shows that the new images were uploaded to Server B 620 by the tournament Application A2 610. At Step 4, Agent A 630 requests and receives images from Server B. For images with prioritized parts of an image, Agent A 630 will create one (or more), for example, HTTP links to each relevant media file in which it has identified the father's son or daughter (FIG. 6 Step 5). The links are visible as any other object would have been in a file manager or other image viewing browsing applications. Images and videos are coded so that the part of the image that his son or daughter is visible in is indicated for higher resolution than the other parts of the image. These links to full resolution images are made available to the father (FIG. 6 Step 6). The father simply clicks on the link and it will be displayed or played as any other media file would have been in a device operating system. Clicking on the link can include clicking on the image or part of the image associated with the link.

In a related approach, a link to an image could include a hierarchical set of links in which “the first link” consists of the son's-face-in-high-resolution-link, whereas following links correspond to other parts of the image file having high (or a selected level of) resolution. The first link could be assigned quality of service (QoS) properties different than other subsequent links.

According to another embodiment related to Steps 508-512 in FIG. 5, a method in the computer server node 12 includes sending a preview digital image towards a wireless device 10 that is communicatively coupled to the computer server node 12 by a wireless connection 16 provided by a wireless communication network 14. The sending may be in response to a request for a digital image corresponding to the preview digital image from a user of the wireless device 10 or as part of a flow or push feed of preview digital images to the wireless device 10. The method includes comparing 1) data resulting from object recognition performed on the digital image corresponding to the preview digital image with 2) corresponding data of a common representation scheme made available by a remote photo library associated with the user (e.g., ICLOUD photo library). The object recognition could be performed upon the request for the digital image or sometime before the request. In some cases, the preview digital image is sent by the wireless device 10 to the remote photo library, which performs object recognition based on the user's photos and sends back an indication that the preview digital image contains a representation of a known object of interest. The method further includes, based on the comparison, sending additional image data, an enhanced digital image or the enhanced version of the preview digital image (e.g., higher resolution) for known objects to the wireless device 10.

### Embodiment 2

In another embodiment based on Embodiment 1, facial analysis is processed on the Server B 620 side directly with known algorithms. Results can be stored as hashes. The same analysis can be performed on the user side (local storage, contact list, etc.), where prioritization of those hashes could be requested. These algorithms can be, for example, APPLE PHOTOS application's face recognition, GOOGLE's photo's DITTO application or an openly available face recognition network that for example can be downloaded from a GITHUB server such as the one found at (https://cmusatyalab.github.io/openface/). These functions identify a face and give that face a hash number. When used locally, a name is connected to that hash number, but that is not necessarily the case here, because the only thing that is needed is to compare these hash numbers. The device sends a message when trying to retrieve the image with the wanted image and a list of prioritized hashes along with the used algorithm on the client side.

For example, HTTP POST can be used by appending the image, algorithm ID and hashes as a list, like as illustrated below:
curl-d′{“image”:nameimag.png, “algorithm”:really-good-CNN-1234, “face-list”:“[hash #0, hash #1, hash #2]”}′-H “Content-Type: application/json”-X POST http://server.adress.html:3000/
   This message will be parsed by the Server B 620 Application and then the correct areas of the image will be downloaded first. The down-prioritized parts can be sent as low-resolution variants, if at all, and subsequently be updated if time and resources permit or based on a user action, such as when a user clicks on the image.

### Embodiment 3

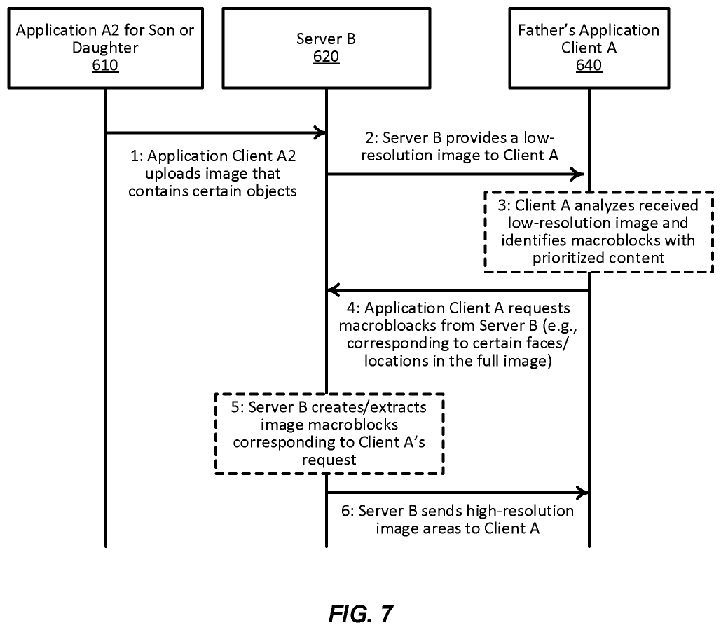

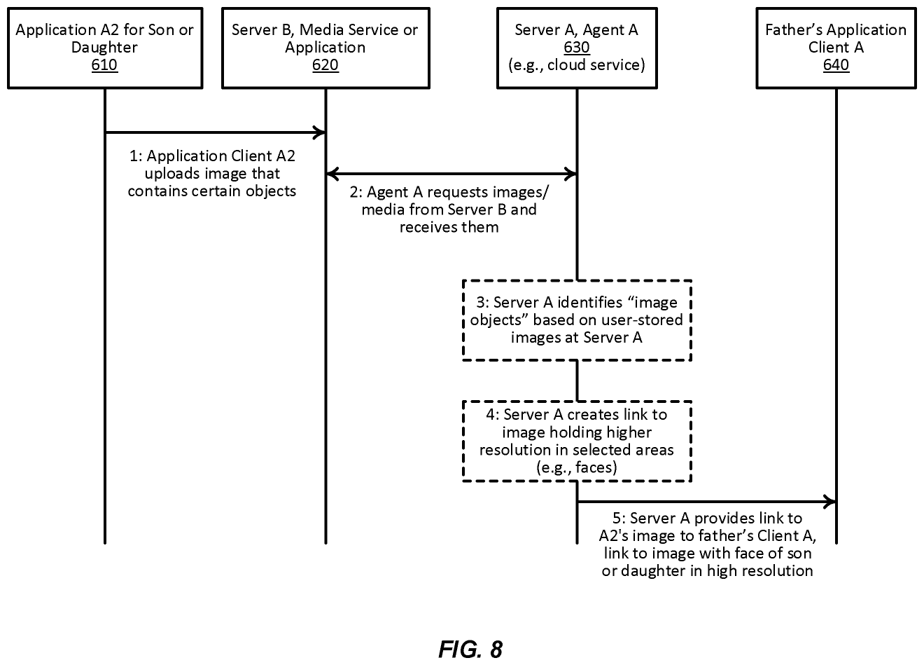

FIG. 7 illustrates a signaling diagram in another embodiment that is more UE-based. After Application A2 610 uploads an image that contains certain objects (Step 1), Application Server B 620 sends a preview image as a low-resolution image to Client A 640 (Step 2). Client A 640 analyzes the preview image and detects a part of the preview image that contains prioritized image criteria based on knowledge of what object of interest to prioritize based on. This knowledge can be based on, for example, content in the father's UE camera folder and/or UE contact list (Step 3). An object of interest can be found in one or more macroblocks within an image. Client A 640 responds to Server B 620 and requests high-resolution macroblock(s) for the area(s) of the full image that contains prioritized image characteristics (Step 4). Server B 620 creates or extracts macroblocks corresponding to the request (Step 5) and sends respective high-resolution image areas to Client A 640 (Step 6).

A benefit of this UE-based approach is that information about what items to prioritize are based on content that stays in the UE. That is, no information is uploaded to Server B 620 and end-user confidentially is thereby enhanced. On the other hand, Server B 620 can, based on the configuration, implicitly deduct what individuals that are of most interest to the father based on statistics, for example, of which faces are often present in requested image area. Still, no image data to be used for training purposes is required to be uploaded outside of the control of the user.

### Embodiment 4

Previous embodiments like embodiments 1 and 2 can be done on a user's cloud service or infrastructure (e.g., APPLE's ICLOUD service, etc.) and can then be transmitted to Server B 620 without having to query the UE. Any processing that can be performed in the network or computer server nodes will improve battery consumption in the father's UE. FIG. 8 is a signaling diagram illustrating how Server/Agent A 630 uses existing images of other data to provide suitable images to Client A 640. Steps 1 and 2 in FIG. 8 correspond to Steps 3 and 4 in FIG. 6. Step 2 in FIG. 8 includes Server A identifying image objects based on user-stored images at Server A. Steps 4 and 5 then correspond to Steps 5 and 6 in FIG. 6.

### Embodiment 5

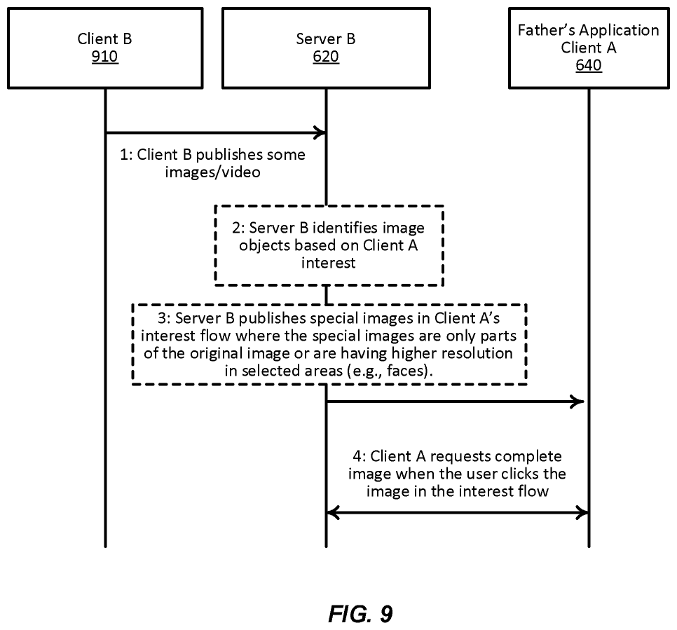

In another example embodiment, Application Server/Agent A 630 is built into the Application A2 610 used by the tournament management. This may be, for example the FACEBOOK page or INSTAGRAM account at the device that is used by the tournament management. The combined component is represented by Client B 910 in FIG. 9, which figure is another example signaling diagram. In this example, Server B 620 represents the network part of the FACEBOOK page or INSTAGRAM account.

In this embodiment, Client B 910 publishes some images or video (Step 1). Server B 620 identifies image objects based on interests determined or obtained by Client A 640 (Step 2). Server B 620 publishes preview digital images, referred to as special images, in Client A's interest flow or feed. The special images are only parts of the original image or are having higher resolution in selected areas (e.g., familiar faces) (Step 3). Client A 640 requests the complete image when the user clicks on the special image in the interest flow or feed (Step 4).

In some embodiments, the media characteristics of what content to prioritize in the father's media flow are automatically based on his history usage and media content. In some embodiments, the media characteristics of what content to prioritize in the father's media flow are based on what images he has marked as favorites in his UE's camera album (or what images he has liked in any shared media albums he has accessed in a cloud-based image sharing solution, such as in an ICLOUD photo album). In other embodiments, the media characteristics of what content to prioritize in his media flow are based on a specific mode/facial expression the kid possesses. For example, only images with the kid being happy are considered, not pictures with a grumpy kid.

The embodiments described herein determine prioritized parts of multimedia content based on user specific information, such as on-device images and user contact information. Based on such a determination, the most relevant parts of an image are rendered first or rendered in higher resolution than other parts of the image. This advantageously improves the user experience by reducing the total data utilization and user latency associated with such media transfers.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-33. (canceled)

34. A method of operation by a wireless device configured for operation in a wireless communication network, the method comprising:
receiving a preview digital image from a computer server node via a wireless connection to the wireless communication network;
applying object recognition processing to the preview digital image, to determine whether the preview digital image contains a representation of a known object of interest; and
responsive to a positive determination:
transmitting an indication of the positive determination to the computer server node via the wireless connection;
receiving, in response to the transmitted indication, an enhanced digital image from the computer server node corresponding to the preview digital image, or receiving additional image data from the computer server node and forming an enhanced version of the preview digital image using the additional image data; and
storing the enhanced digital image or the enhanced version of the preview digital image at least temporarily in the wireless device.

35. The method of claim 34, wherein the known object of interest is known from local information or extracted data therefrom, the local information being resident in the wireless device and associated with a user.

36. The method of claim 34, further comprising determining the known object of interest by comparing feature information extracted from the preview image with an object template library stored in the wireless device, the object template library being stored as object data in the wireless device.

37. The method of claim 34, wherein the known object of interest is known based on at least one of: a user-provided designation for a certain object represented in one or more digital images in a photo library associated with a user; and detection, via object recognition processing applied to the photo library, that more than a defined threshold number of the digital images in the photo library contain representations of the certain object.

38. The method of claim 34, wherein the known object of interest is defined in known-object data stored in the wireless device, and wherein applying the object recognition processing to the preview digital image comprises correlating or comparing image data comprising the preview digital image, or metrics derived therefrom, with the known-object data stored in the wireless device.

39. The method of claim 38, wherein the known-object data comprises facial representation data for one or more reference faces, and wherein correlating or comparing the image data comprising the preview digital image, or metrics derived therefrom, with the known-object data comprises performing facial recognition processing on the preview digital image and comparing any detected faces with the one or more reference faces, wherein the comparison uses a common representation scheme for the detected faces and the reference faces.

40. The method of claim 34, wherein the preview digital image has a first resolution, wherein the indication of the positive determination is a request for further image data for rendering a region of the preview digital image containing the representation of the known object of interest at a second resolution that is higher than the first resolution, and wherein receiving the enhanced digital image or the additional image data comprises receiving the further image data as the additional image data and enhancing the region of the preview digital image containing the representation of the known object of interest using the further image data, to obtain the enhanced version of the preview digital image.

41. The method of claim 40, wherein the preview digital image comprises a set of macro blocks and wherein requesting the further image data includes identifying the one or more macro blocks constituting the region of the preview digital image containing the representation of the known object of interest.

42. The method of claim 34, wherein the preview digital image has a first resolution, wherein the indication is a request for the enhanced digital image, the enhanced digital image having a second resolution that is higher than the first resolution.

43. A wireless device configured for operation in a wireless communication network, the wireless device comprising:
communication circuitry configured for wirelessly connecting to the wireless communication network; and
processing circuitry configured to:
receive, via the communication circuitry, a preview digital image from a computer server node, the preview digital image sent to the wireless device over a wireless connection between the wireless device and the wireless communication network;
apply object recognition processing to the preview digital image, to determine whether the preview digital image contains a representation of a known object of interest; and
responsive to a positive determination:
transmit, via the communication circuitry, an indication of the positive determination to the computer server node via the wireless communication network;
receive, via the communication circuitry and in response to the transmitted indication, an enhanced digital image from the computer server node corresponding to the preview digital image, or receive additional image data from the computer server node and form an enhanced version of the preview digital image using the additional image data; and
store the enhanced digital image or the enhanced version of the preview digital image at least temporarily in the wireless device.

44. The wireless device of claim 43, wherein the known object of interest is known from local information or extracted data therefrom, the local information being resident in the wireless device and associated with a user.

45. The wireless device of claim 43, wherein the processing circuitry is further configured to determine the known object of interest by determining the known object of interest by comparing feature information extracted from the preview image with an object template library stored in the wireless device, the object template library being stored as object data in the wireless device.

46. The wireless device of claim 43, wherein the known object of interest is known based on at least one of: a user-provided designation for a certain object represented in one or more digital images in a photo library associated with a user; and detection, via object recognition processing applied to the photo library, that more than a defined threshold number of the digital images in the photo library contain representations of the certain object.

47. The wireless device of claim 43, wherein the known object of interest is defined in known-object data stored in the wireless device, and, wherein, as said object recognition processing applied to the preview digital image, the processing circuitry is configured to correlate or compare image data comprising the preview digital image, or metrics derived therefrom, with the known-object data stored in the wireless device.

48. The wireless device of claim 47, wherein the known-object data comprises facial representation data for one or more reference faces, and wherein, as said object recognition processing applied to the preview digital image, the processing circuitry is configured to correlate or compare the image data comprising the preview digital image, or the metrics derived therefrom, with the known-object data by performing facial recognition processing on the preview digital image and comparing any detected faces with the one or more reference faces, wherein, for the comparison, the processing circuitry is configured to use a common representation scheme for the detected faces and the reference faces.

49. The wireless device of claim 43, wherein the preview digital image has a first resolution, wherein, as the indication of the positive determination, the processing circuitry is configured to transmit, via the communication circuitry, a request for further image data for rendering a region of the preview digital image containing the representation of the known object of interest at a second resolution that is higher than the first resolution, and wherein the processing circuitry is configured to receive, via the communication circuitry, the further image data as the additional image data and enhance the region of the preview digital image containing the representation of the known object of interest using the further image data, to obtain the enhanced version of the preview digital image.

50. The wireless device of claim 49, wherein the preview digital image comprises a set of macro blocks and wherein the processing circuitry is configured to request the further image data by identifying the one or more macro blocks constituting the region of the preview digital image containing the representation of the known object of interest.

51. The wireless device of claim 43, wherein the preview digital image has a first resolution and wherein the processing circuitry is configured to transmit, as the indication of the positive determination, a request for the enhanced digital image, the enhanced digital image having a second resolution that is higher than the first resolution.

52. A method of operation by a computer server node, the method comprising:
sending a preview digital image towards a wireless device that is communicatively coupled to the computer server node by a wireless connection provided by a wireless communication network;
receiving an indication originating from the wireless device in response to the wireless device detecting a representation of a known object of interest in the preview digital image; and
responding to the indication by sending towards the wireless device an enhanced digital image corresponding to the preview digital image, or by sending additional image data for use by the wireless device in enhancing the preview digital image.

53. The method of claim 52, wherein the indication comprises a request for the enhanced digital image and wherein responding to the indication comprises sending the enhanced digital image.

54. The method of claim 52, wherein the indication comprises a request for further image data for a region of the preview digital image, and wherein responding to the indication comprises sending, as the additional image data, the further image data identified in the request.

55. The method of claim 54, wherein the request for the further image data comprises an identification of one or more macro blocks of the preview digital image, wherein the preview digital image comprises a set of macro blocks, and wherein sending the further image data comprises sending additional image data for the identified macro blocks.

56. A computer server node comprising:
communication circuitry configured to communicate directly or indirectly with a wireless device that is communicatively coupled to the computer server node via a wireless connection to a wireless communication network; and
processing circuitry operatively associated with the communication circuitry and configured to:
send a preview digital image towards the wireless device;
receive an indication originating from the wireless device in response to the wireless device detecting a representation of a known object of interest in the preview digital image; and
respond to the indication by sending towards the wireless device an enhanced digital image corresponding to the preview digital image, or by sending additional image data for use by the wireless device in enhancing the preview digital image.

57. The computer server node of claim 56, wherein the indication comprises a request for the enhanced digital image, and wherein the processing circuitry is configured to respond to the request by sending, via the communication circuitry, the enhanced digital image.

58. The computer server node of claim 56, wherein the indication comprises a request for further image data for a region of the preview digital image, and wherein the processing circuitry is configured to respond to the request by sending, via the communication circuitry and as the additional image data, the further image data identified in the request.

59. The computer server node of claim 56, wherein the request for the further image data comprises an identification of one or more macro blocks of the preview digital image, wherein the preview digital image comprises a set of macro blocks, and wherein the processing circuitry is configured to respond to the request by sending, via the communication circuitry, additional image data for the identified macro blocks.
